(19) United States
(12) Patent Application Publication
(10) Pub. No.: US 2007/0121514 A1
(43) Pub. Date: May 31, 2007

(54) Method for negotiating bearer properties in ip networks

(76) Inventors: Peter Goldstein, Thalwil (CH); Rudiger Kreuter, Munchen (DE); Rita Leirich, Munchen (DE); Egid Pichlmair, Bockhorn (DE); Bernd Siegwart, Ettringen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/588,352

(22) PCT Filed: Feb. 1, 2005
(86) PCT No.: PCT/EP05/50432

§ 371 Date: Aug. 3, 2006

(30) Foreign Application Priority Data
Feb. 6, 2004 (DE) 10 2004 005 936.5

(51) Int. Cl. H04L 12/26

(52) U.S. Cl. 370/236; 370/401

(57) ABSTRACT

In one aspect, a method for negotiating bearer properties in a communication network providing a plurality of Media Gateway Controllers and a plurality of Media Gateways, in which bearer properties are maintained, and maintaining reference lists in the Media Gateway Controllers, the reference list comprising influenceable bearer properties is provided.

### CROSS REFERENCE TO RELATED APPLICATIONS

This application is the US National Stage of International Application No. PCT/EP2005/050432, filed Feb. 1, 2005 and claims the benefit thereof. The International Application claims the benefits of German application No. 102004005936.5 filed Feb. 6, 2004, both of the applications are incorporated by reference herein in their entirety.

### FIELD OF INVENTION

The present invention relates to a method for negotiating bearer properties in IP networks.

### BACKGROUND OF INVENTION

Newer communication architectures, which use packet-based or cell-based methods for voice signal transmission, such as Voice-over-IP (VoIP) or Voice-over-ATM (VoATM) for example, make provision for the separation of call control and user channel control. The communication between one or more subscribers such as ISDN subscribers, previously routed via conventional circuit-switched telecommunications networks for example, is then routed via IP networks. Conventional analog or ISDN terminals can continue to be used as terminals. The basic circumstances for ISDN subscribers between whom an Internet IP is arranged, can be taken from FIG. 1.

Basically the call processing networks are subdivided into units used for the transport of bearer information and units used for bearer control. To continue to make it possible to communicate using conventional circuit-switched telecommunication networks, e.g. PSTNs (Public Switched Telephone Networks), a “translation” between these two different transport technologies is required, which is undertaken in the coupling points.

At such a coupling point the first transport technology for the bearer information is converted into the second transport technology by means of specific devices known as Media Gateways (MG). Media Gateways possess both interfaces to PSTN/ISDN and also IP/ATM networks and thus form the interfaces between circuit-switched and packet-oriented networks. They can convert TDM (Time Division Multiplexing)-based voice transmission into packet (VoIP)-/cell (VoATM)-based voice transmission and vice-versa.

The Media Gateways are controlled by central entities, the Media Gateway Controllers (MGC) (FIG. 1). The signaling information transmitted between two Media Gateway Controllers is transported for example by means of a BICC (Bearer Independent Call Control) protocol. The Media Gateway Controllers are used essentially for coordination of the Media Gateways and monitor/control (bearer) connections between the Media Gateways. The Media Gateways are controlled with the aid of the MGCP (Media Gateway Controller Protocol) or also the H.248 protocol.

Basically the transmission properties are defined in the Media Gateways. If for example the subscriber of an A-law country wishes to set up a connection to a subscriber located in a μ-law country these properties come into play. If the user information of the two subscribers is encoded in accordance with different laws, the user information must be converted. This problem arises for example with international telephone and data traffic from Europe (A-Law) to the USA (μ-law).

Before the conversion process the Media Gateways included in the information flow must negotiate with each other per connection setup jointly-supported “codecs and capabilities” (bearer properties) and agree on specific settings. To this end each Media Gateway maintains a list of bearer properties which it supports and which are already predetermined ex-works.

### SUMMARY OF INVENTION

The problem with this is that only the two Media Gateways thus have knowledge of the negotiated properties. Under some circumstances however the network operator would now like, for network policy reasons (e.g. for economic reasons) to negotiate specific bearer properties (e.g. codecs) with a priority other than that negotiated by the Media Gateways, or be able to exclude specific bearer properties (e.g. codecs, RFC2833, T38) altogether. This is not possible with this prior art.

An object of the invention is to demonstrate a way in which the negotiation of the bearer properties can be designed in such a manner that the rules for it can be modified at any time.

The object of the invention is achieved, using the features specified in the independent claim.

The advantage of the invention is its provision and maintenance of an additional reference list in the Media Gateway Controller. This provides the “network policy” in the Media Gateway Controller at a central point in the network. The Media Gateway Controller is thus given a master function in the network, i.e. its reference list is solely responsible for the group of Media Gateways controlled by the Media Gateway Controller independently of the status of the lists kept here. This allows the network operator to administer the bearer properties regardless of the size of his network (number of all Media Gateways/IP clients).

The simple modification of the network policy is achieved by undesired (i.e. unknown or blocked) bearer properties being filtered out by a comparison with the reference list in the Media Gateway Controller. The Media Gateway Controller of the A-side then re-assigns the priorities for the bearer properties remaining after the filtering on the basis of its own reference list. This additional reference list in the Media Gateway Controller thus inserts a filter in the negotiation of the bearer properties between the Media Gateways and the partner Media Gateway Controller.

The invention is not restricted solely to Media Gateways/Media Gateway Controllers. It can also be applied in a similar manner to IP clients. Likewise the invention can also be applied to other networks or transport technologies such as ATM or MPLS for example, IP networks are not absolutely mandatory, although the invention is described with reference to IP networks.

Advantageous developments of the invention are specified in the dependent claims.

### BRIEF DESCRIPTION OF THE DRAWINGS

The invention is explained in greater detail below with reference to exemplary embodiments shown in the form of Figures.

The figures show:

FIG. 1 a network configuration with PSTN/ISDN terminals, Media Gateways and Media Gateway Controllers,

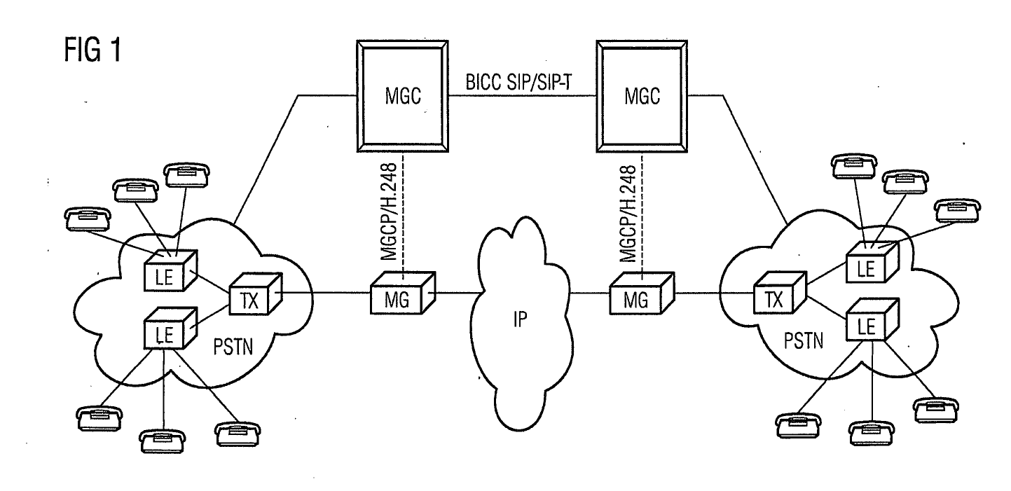

FIG. 2 the method in accordance with the invention

### DETAILED DESCRIPTION OF INVENTION

In accordance with the invention each Media Gateway Controller is allocated a reference list. This contains the bearer properties which the network operator concerned supports in their network. This can for example be a predetermined number of codecs or a prioritization of the codecs. The reference list of the bearer properties and the priority of the relevant bearer properties should be able to be administered. In this way the network operator can configure the bearer properties in the few Media Gateway Controllers as required.

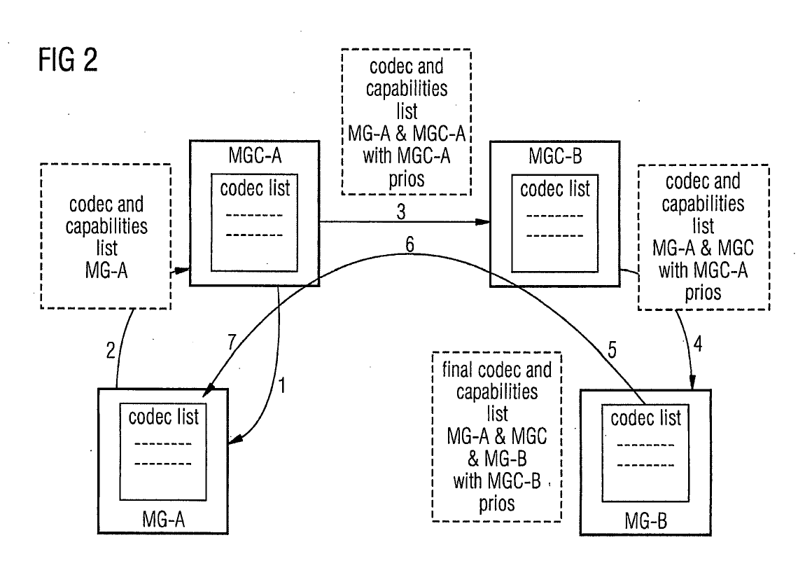

In the present exemplary embodiment it is assumed, as shown in FIG. 2, that a subscriber of the A-side wishes to establish a connection to a subscriber of the B-side. The Media Gateway Controller MGC-A of the A-side is informed about this during the connection setup. Subsequently its reference list is compared with the list of the Media Gateway MG-A of the A-side (steps 1, 2) and the intersection between the two lists is formed. For example all bearer properties can be removed which are not in the own reference list or which are blocked in the own reference list. The result is notified by the Media Gateway Controller MGC-A to the Media Gateway Controller MGC-B of the B-side (step 3).

If the result (e.g. the new codec selected) is not supported by the Media Gateway Controller MGC-B of the B-side, the A-side is notified via a corresponding acknowledgement message of a rejection. Else this result is offered to the Media Gateway MG-B of the B-side (step 4). The bearer properties not supported here are removed from the offer and the result is incorporated into a list. This list is then made available via the Media Gateway Controller MGC-B of the B-side (step 5) and the Media Gateway Controller MGC-A of the A-side (step 6) to the Media Gateway MG-A of the A-side (step 7).

The negotiation is part of the connection setup. The user information can now be transmitted between the Media Gateway MG-A of the A-side and the Media Gateway MG-B of the B-side in accordance with the bearer properties negotiated.

1.-7. (canceled)

8. A method for negotiating bearer properties in a communication network, comprising:
providing a plurality of Media Gateway Controllers and a plurality of Media Gateways, in which bearer properties are maintained; and
maintaining reference lists in the Media Gateway Controllers, the reference list comprising influenceable bearer properties.

9. The method in accordance with claim 8, wherein a negotiation of the bearer properties are influenced by a configuration undertaken by a network operator.

10. The method in accordance with claim 8, wherein a least one of the Media Gateway Controllers includes a master function for the group of Media Gateways the Media Gateway Controller controls.

11. The method in accordance with claim 8, wherein a negotiation of the communication networks are embodied as IP networks.

12. The method in accordance with claim 8, wherein the bearer properties are embodied as a prioritization of codecs.

13. The method in accordance with claim 8, wherein the bearer properties are embodied as codecs.

14. The method in accordance with claim 13, wherein the bearer properties are embodied as a prioritization of the codecs.

15. The method in accordance with claim 8, wherein a negotiation of the bearer properties is always undertaken via Media Gateway Controllers.

16. The method in accordance with claim 15, wherein the bearer properties are embodied as codecs.

17. The method in accordance with claim 16, wherein a least one of the Media Gateway Controllers includes a master function for the group of Media Gateways the Media Gateway Controller controls.

18. The method in accordance with claim 17, wherein a negotiation of the bearer properties are influenced by a configuration undertaken by a network operator.

19. A method for negotiating bearer properties in a communication network, comprising:
providing a first Media Gateway Controller including a reference list having bearer properties, the reference list administrable by a network operator;
providing a first Media Gateway communicatively coupled to the first Media Gateway Controller, the first Media Gateway including a reference list having bearer properties;
informing the first Media Gateway Controller of a connection set up request;
comparing the reference list of the first Media Gateway Controller with a reference list of the first Media Gateway Controller; and
forming an intersection of the bearer properties between the compared lists.

20. The method according to claim 19, wherein the intersection is formed by removing the bearer properties in the reference list of the first Media Gateway that are not in the reference list of the first Media Gateway Controller.

21. The method according to claim 19, wherein the intersection is formed by removing the bearer properties in the reference list of the first Media Gateway that are blocked via the reference list of the first Media Gateway Controller.

22. The method according to claim 19, further comprising:
providing a second Media Gateway Controller including a reference list having bearer properties;
providing a second Media Gateway communicatively coupled to the second Media Gateway Controller and communicatively coupled to the first Media Gateway;
notifying the second Media Gateway Controller of the intersection; and
determining if the intersection is supported by the second Media Gateway Controller.

23. The method according to claim 22, further comprising:
sending a rejection if the reference list of the second Media Gateway Controller does not support a bearer property included in the intersection.

24. The method according to claim 22, further comprising:
removing the bearer properties in the intersection that are not in the reference list of the second Media Gateway Controller; and
sending the updated intersection to the first Media Gateway.

25. The method according to claim 22, further comprising:
removing the bearer properties in the intersection that are blocked by the reference list of the second Media Gateway Controller; and
sending the updated intersection to the first Media Gateway.

26. The method in accordance with claim 22, wherein the bearer properties are embodied as a prioritization of codecs.

27. The method in accordance with claim 22, wherein the bearer properties are embodied as codecs.
